(19) United States
(12) Patent Application Publication
(10) Pub. No.: US 2026/0281260 A1
(43) Pub. Date: Sep. 17, 2026

(54) INFORMATION PROCESSING SYSTEM, INFORMATION PROCESSING METHOD, AND NON-TRANSITORY COMPUTER READABLE MEDIUM

(71) Applicant: FUJIFILM Business Innovation Corp, Tokyo (JP)

(72) Inventors: Masanori SATAKE, Kanagawa (JP); Risa HAYASHI, Kanagawa (JP); Yuki KANAZAWA, Kanagawa (JP); Ryosuke MASUKO, Kanagawa (JP); Natsuko KATO, Kanagawa (JP); Naoto IKEDA, Kanagawa (JP)

(73) Assignee: FUJIFILM Business Innovation Corp, Tokyo (JP)

(21) Appl. No.: 19/333,065

(22) Filed: Sep. 18, 2025

(30) Foreign Application Priority Data
Mar. 17, 2025 (JP) 2025-042944

(51) Int. Cl. H04N 1/00

(52) U.S. Cl. CPC H04N 1/00413; H04N 1/00482

(57) ABSTRACT

An information processing system includes a processor configured to: cause one operation item to be displayed in a first area of a display screen; cause another operation item different from the one operation item to be displayed in a second area different from the first area of the display screen; and upon accepting acquisition of information pertaining to the other operation item, cause information pertaining to the other operation item to be displayed in the second area while maintaining the display state of the one operation item in the first area.

### CROSS-REFERENCE TO RELATED APPLICATIONS

This application is based on and claims priority under 35 USC 119 from Japanese Patent Application No. 2025-042944 filed Mar. 17, 2025.

### BACKGROUND

### (i) Technical Field

The technology of the present disclosure relates to an information processing system, an information processing method, and a non-transitory computer readable medium.

### (ii) Related Art

The display control device described in Japanese Unexamined Patent Application Publication No. 2023-179561 includes a processor and a memory connected to or internal to the processor, and is for controlling display of an operation screen of an information appliance, wherein if any setting item is selected from among multiple setting items displayed in list form on the operation screen, the processor is configured to display the selected setting item in an upper portion of the display area where the multiple setting items had been displayed in list form, and additionally display a related setting item related to the selected setting item below the selected setting item.

### SUMMARY

Aspects of non-limiting embodiments of the present disclosure relate to information processing whereby, for a configuration in which multiple operation items are displayed in first and second areas of a display screen, reduced operability of an operation item displayed in the first area is suppressed as compared to the case in which information related to an operation item displayed in the second area is displayed in an area that includes the first area.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: cause one operation item to be displayed in a first area of a display screen; cause another operation item different from the one operation item to be displayed in a second area different from the first area of the display screen; and upon accepting acquisition of information pertaining to the other operation item, cause information pertaining to the other operation item to be displayed in the second area while maintaining the display state of the one operation item in the first area.

### BRIEF DESCRIPTION OF THE DRAWINGS

Exemplary embodiments of the present disclosure will be described in detail based on the following figures, wherein:

FIG. 1 is a front view of an image forming device according to a first exemplary embodiment of the technology of the present disclosure;

FIG. 2 is a block diagram illustrating a hardware configuration of an image forming device according to a first exemplary embodiment;

FIG. 3 is a schematic diagram illustrating a screen configuration of a touch panel according to a first exemplary embodiment;

FIG. 4 is a schematic diagram illustrating an intermediate state when causing a guidance message to be displayed on the touch panel in FIG. 3;

FIG. 5 is a schematic diagram illustrating a state when performing an operation for ending a guidance message displayed on a touch panel according to a first exemplary embodiment;

FIG. 6 is a schematic diagram of a touch panel illustrating an intermediate state when ending a guidance message;

FIG. 7 is a flowchart of an information processing program according to a first exemplary embodiment;

FIG. 8 is a schematic diagram illustrating an intermediate state when causing a guidance message to be displayed on a touch panel according to a first exemplary modification;

FIG. 9 is a schematic diagram illustrating a state in which a guidance message displayed on a touch panel is scrolled down by a rightward slide operation according to a second exemplary modification;

FIG. 10 is a schematic diagram illustrating the state of the guidance message that has been scrolled from the state in FIG. 9;

FIG. 11 is a schematic diagram illustrating a screen configuration of a touch panel according to a second exemplary embodiment of the technology of the present disclosure;

FIG. 12 is a schematic diagram illustrating an intermediate state when causing a guidance message to be displayed on the touch panel in FIG. 11;

FIG. 13 is a schematic diagram illustrating that an operation for increasing the “number of copies” is being performed while a guidance message related to “duplex” is displayed on the touch panel according to a second exemplary embodiment;

FIG. 14 is a schematic diagram of a touch panel indicating an intermediate state when ending a guidance message related to “duplex” through intervention in an operation for increasing the “number of copies”;

FIG. 15 is a flowchart of an information processing program according to a second exemplary embodiment;

FIG. 16 is a schematic diagram illustrating an intermediate state when displaying a guidance message after having scrolled up the entire second area so that the operation item at the bottom that had been displayed partially on the touch panel in FIG. 11 is displayed in entirety according to an exemplary modification of the second exemplary embodiment; and

FIG. 17 is a schematic diagram illustrating a state in which a guidance message is displayed on a touch panel according to an exemplary modification of the second exemplary embodiment.

### DETAILED DESCRIPTION

Hereinafter, exemplary embodiments of the technology of the present disclosure will be described with reference to the drawings. Note that in the drawings, identical or similar components and portions are denoted with the same reference signs.

### First Exemplary Embodiment

### (Image Forming Device 10)

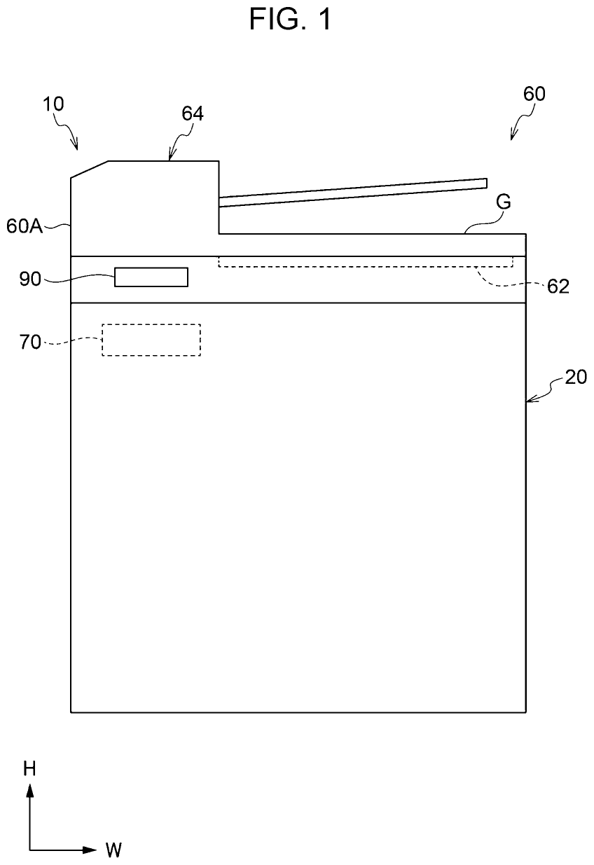

FIG. 1 is a front view of an image forming device according to a first exemplary embodiment of the technology of the present disclosure. The image forming device 10 is a device that forms an image on a recording medium (not illustrated). For example, an electrophotographic image forming device that uses toner to form an image onto a recording medium is used as the image forming device 10.

The image forming device 10 is provided with an image forming unit 20, an original reading unit 60, a touch panel 90, and a controller 70.

The image forming unit 20 performs steps such as charging, exposing, developing, and transferring and fusing onto a recording medium, for example.

The original reading unit 60 is disposed above the image forming unit 20 and reads an original G transported from a transport device 64 above a housing 60A of the original reading unit 60 or an original G temporarily placed on top of a transparent plate 62 below the housing 60A.

The touch panel 90 is for displaying the status and the like of the image forming device 10 and is disposed at any location on the image forming device 10, such as above the image forming unit 20, for example. The touch panel 90 is assumed to be capable of indicating the status of the image forming device 10 and accepting operations performed by a user U. The touch panel 90 functions as a user interface of the image forming device 10.

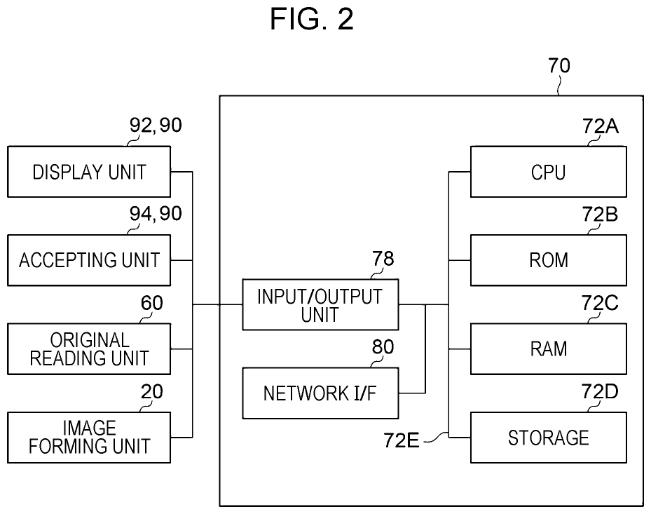

The touch panel 90 is provided with a display unit 92 and an accepting unit 94 (see FIG. 2). The display unit 92 is a liquid crystal display, for example, and displays various information. The accepting unit 94 accepts operations performed in response to information on the display unit 92. In other words, the accepting unit 94 accepts information selected by the user U from among the various information displayed by the display unit 92. Details of the touch panel 90 will be described later.

### (Controller)

The controller 70 controls each component of the image forming device 10. As illustrated in FIG. 2, the controller 70 includes the following components: a central processing unit (CPU) 72A, read-only memory (ROM) 72B, random access memory (RAM) 72C, storage 72D, an input/output unit 78, and a network interface (network I/F) 80. These components are communicatively interconnected through a bus 72E. The controller 70 is an example of an information processing system.

The CPU 72A is a central processing unit that executes various programs and controls each unit. In other words, the CPU 72A reads out a program from the ROM 72B or the storage 72D, and executes the program while using the RAM 72C as a work area. The CPU 72A is an example of a processor, and a control program executed by the CPU 72A is an example of an information processing program. The CPU 72A controls each of the above units and performs various types of arithmetic processing according to a program recorded in the ROM 72B or the storage.

The ROM 72B stores various programs and various data. The RAM 72C temporarily stores programs or data as a work area. The storage 72D includes a hard disk drive (HDD) or a solid-state drive (SSD), and stores various programs, including an operating system, as well as various data pertaining to guidance messages described later.

The input/output unit 78 accepts signals between components of the image forming device 10 for exhibiting the functions of the image forming device 10. Specifically, the input/output unit 78 is connected to the touch panel 90 (display unit 92 and accepting unit 94), the original reading unit 60, and the image forming unit 20, and is also connected to the CPU 72A and the like.

The network I/F 80 is an interface for communicating with other equipment such as a database or server not illustrated, and implements a standard such as Ethernet®, FDDI, or Wi-Fi®, for example.

With this arrangement, the image forming device 10 forms an image onto a recording medium.

### (Details of Touch Panel)

Next, details of the touch panel 90 will be described. Multiple pieces of information are displayed as images on the display screen 92A of the display unit 92 of the touch panel 90. The multiple pieces of information may be multiple pieces of information with interrelated properties arranged and displayed on the same screen, and/or multiple pieces of information in a hierarchical structure displayed in different parts of the same screen or displayed on different screens.

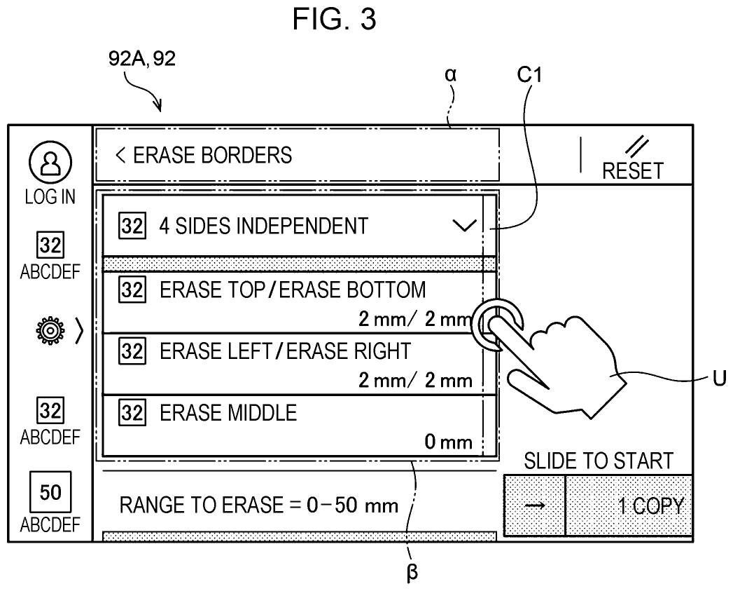

In the present exemplary embodiment, as illustrated in FIG. 3, the display screen 92A of the display unit 92 includes a first area α and a second area β.

Note that the first area α and the second area β in the present disclosure are not assumed to be static areas of the display screen 92A, and depending on the content of the information to be displayed, these areas may or may not be displayed on the display screen 92A, and if displayed, may be displayed with the display position and/or size changed.

In the example in FIG. 3, the first area α is located in the upper part within the display screen 92A. A title item is located in the first area α. The title item is assumed to be an operation item indicating the title of the function that the user U is intending to use. The title item in the present exemplary embodiment is assumed to be “erase borders”. Hereinafter, an operation item displayed in the first area α is referred to as a first operation item. The first operation item is an example of one operation item.

The second area β is assumed to be an area different from the first area α. In the example in FIG. 3, the second area β is located in the center of the display screen 92A, and is set as a rectangular area. In the second area β, four operation items are arranged and displayed in an independently selectable manner. The four operation items are assumed to be “4 sides independent”, “erase top/erase bottom”, “erase left/erase right”, and “erase middle”. “4 sides independent” is assumed to be one pattern of the first operation item “erase borders”. “Erase top/erase bottom”, “erase left/erase right”, and “erase middle” include respectively corresponding numerical values. Hereinafter, an operation item displayed in the second area β is referred to as a second operation item. The second operation item is an example of another operation item. Also, “4 sides independent”, “erase top/erase bottom”, “erase left/erase right”, and “erase middle” are an example of multiple interrelated operation items. The second area β includes a first call area C1.

### (First Call Area C1)

The first call area C1 is assumed to be an area that the user U taps to call a guidance message described later. The tapping of the first call area C1 is an example of an accepting operation. The first call area C1 is located in the second area β. In the present exemplary embodiment, the first call area C1 is set as a vertically long rectangular area, one of which is located in a right edge portion of the second area β. In the present exemplary embodiment, the first call area C1 is assumed to be visually indistinguishable from the other portions of the second area β by the user U. In other words, the first call area C1 is not visible to the user U.

### (Guidance Message)

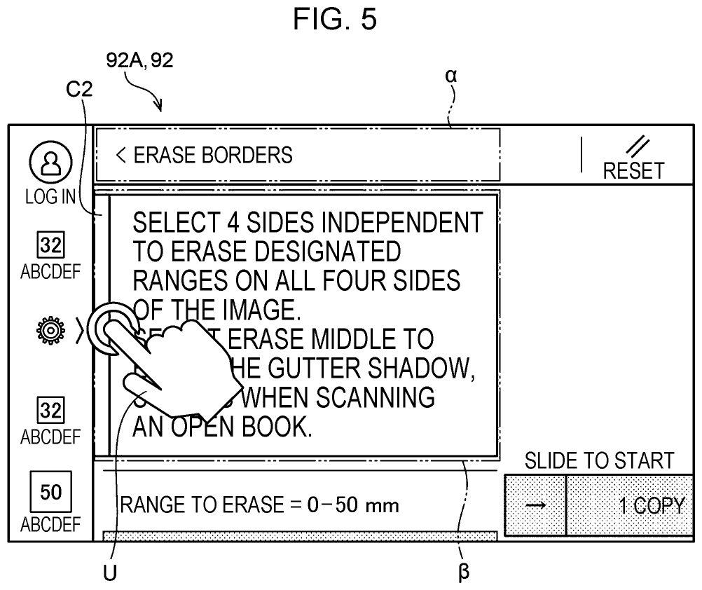

The guidance message is an example of information pertaining to an operation item. As illustrated in FIG. 5, in the present exemplary embodiment, the guidance message is assumed to be a message explaining the function of “4 sides independent” and containing information that is useful to the user U in regard to image formation. In the present exemplary embodiment, the following is displayed as an example of the guidance message: “Select 4 sides independent to erase designated ranges on all four sides of the image. Select erase middle to erase the gutter shadow, such as when scanning an open book.”

The guidance message is displayed in the entire second area β. While the guidance message is displayed in the second area β, the second operation item is not displayed in the portion where the guidance message is displayed. Conversely, while the second operation item is displayed in the second area β, the guidance message is not displayed in the portion where the second operation item is displayed. In other words, the guidance message is switched out with the second operation item. The second area β includes a second call area C2.

### (Second Call Area C2)

The second call area C2 is assumed to be an area that the user U taps to call the second operation item. If the user U taps the second call area C2, the display of the guidance message that had been displayed on the display screen 92A is ended, and the second operation item is displayed in the second area β. The tapping of the second call area C2 is an example of a displaying operation. The second call area C2 is located in the second area β. In the present exemplary embodiment, the second call area C2 is set as a vertically long rectangular area that is located in a left edge portion of the second area β when the guidance message is displayed in the second area β. In the present exemplary embodiment, the second call area C2 is assumed to be visually distinguishable from the other portions of the second area β by the user U. In other words, the second call area C2 is visible to the user U.

With this arrangement, the touch panel 90 according to the present exemplary embodiment is configured.

### (Switching Between Second Operation Item and Guidance Message)

The switching between the second operation item and the guidance message will be described using an example. Note that during this switching, the first area α is assumed to remain in the state with the first operation item displayed.

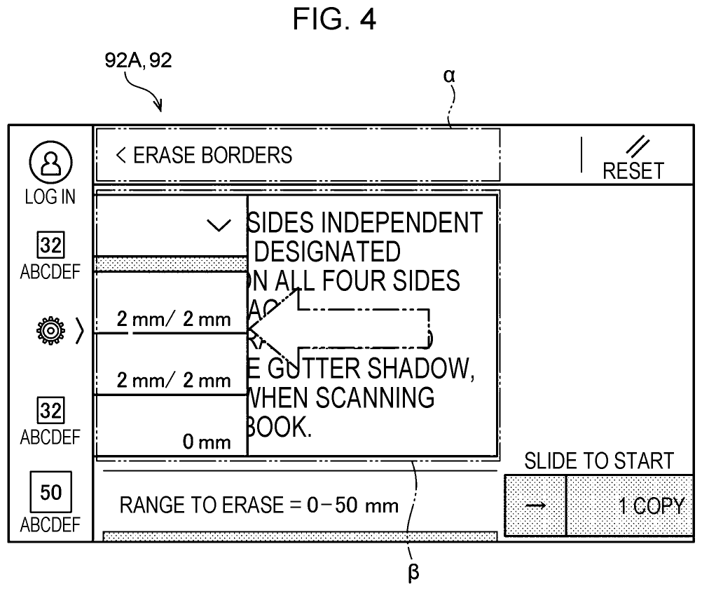

First, an example of switching from the second operation item to the guidance message will be described. As illustrated in FIG. 3, the user U taps the first call area C1 out of the second operation item displayed in the second area β. When the first call area C1 is tapped, as illustrated in FIG. 4, the second operation item that had been displayed so as to cover the guidance message slides to the left, gradually revealing the guidance message. Thereafter, as illustrated in FIG. 5, the guidance message is displayed in the second area β. The second operation item that has slid to the left becomes located outside the second area β and is no longer visible to the user U.

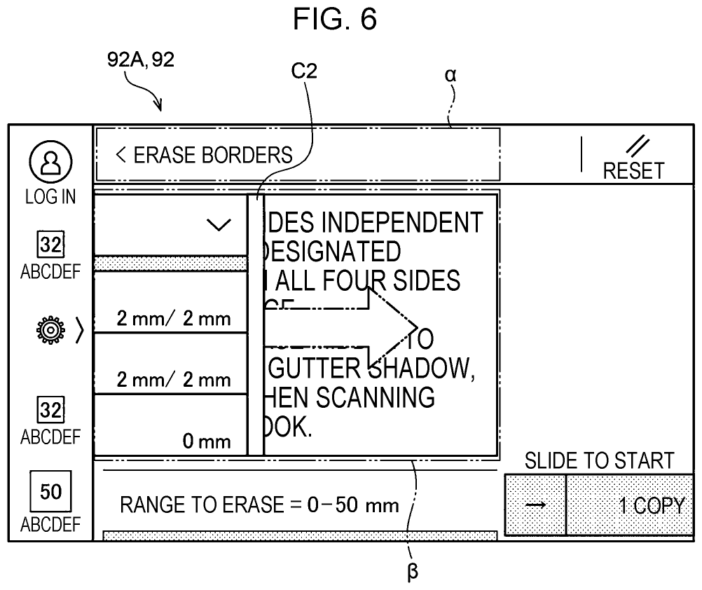

Next, switching from the guidance message to the second operation item will be described. The user U taps the second call area C2 displayed in a left edge portion of the guidance message. When the second call area C2 is tapped, as illustrated in FIG. 6, the second operation item slides to the right and begins to be displayed so as to cover the guidance message. Thereafter, as illustrated in FIG. 3, the second operation item is displayed in the second area β. The guidance message becomes covered by the second operation item and is no longer visible to the user U. In other words, tapping the second call area C2 means the end of the display of the guidance message and the resumption of the display of the second operation item in the second area β.

With this arrangements, switching between the second operation item and the guidance message is carried out.

### (Flowchart)

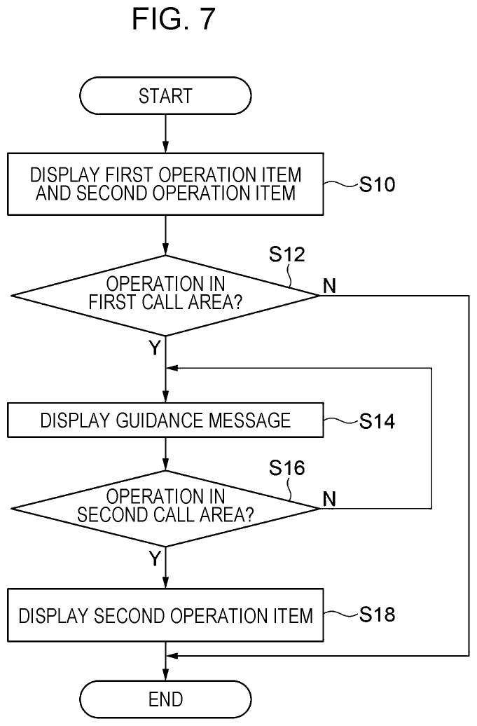

Next, a flowchart pertaining to the switching of the display in the second area β by the controller 70 will be described with reference to FIG. 7.

In step S10, the CPU 72A of the controller 70 causes the first operation item to be displayed in the first area α and causes the second operation item to be displayed in the second area β of the display screen 92A. The CPU 72A then proceeds to step S12.

In step S12, the CPU 72A determines whether the first call area C1 is tapped.

If the determination result is “N”, indicating negation, the CPU 72A ends the flow.

On the other hand, if the determination result is “Y”, indicating affirmation, the CPU 72A proceeds to step S14.

In step S14, the CPU 72A causes the guidance message to be displayed in the second area β of the display screen 92A. The CPU 72A then proceeds to step S16.

In step S16, the CPU 72A determines whether the second call area C2 is tapped.

If the determination result is “N”, the CPU 72A proceeds to step S14 until the condition is met.

On the other hand, if the determination result is “Y”, the CPU 72A proceeds to step S18.

In step S18, the CPU 72A causes the second operation item to be displayed in the second area β of the display screen 92A. The CPU 72A then ends the flow.

With this arrangement, switching of the display in the second area β by the controller 70 according to the present exemplary embodiment is carried out.

### EXEMPLARY MODIFICATIONS

The foregoing describes the first exemplary embodiment of the present disclosure with reference to the drawings, but the present disclosure is not limited to such an exemplary embodiment, and it is clear to a person skilled in the art that the present disclosure make take form in various other embodiments within the scope of the present disclosure.

Note that in the following description of exemplary modifications, reference signs and descriptions may be reduced or omitted with respect to configurations and functions shared in common with the exemplary embodiment above.

### First Exemplary Modification

As an example, the exemplary embodiment above may adopt the following first exemplary modification. The first exemplary modification shares the same basic configuration as the exemplary embodiment above. The first exemplary modification differs in that tapping, which is an example of an accepting operation in the exemplary embodiment above, is changed to dragging as an example of an accepting operation. Specifically, in the first exemplary modification, the first call area C1 in the exemplary embodiment above is set over the entire second area β.

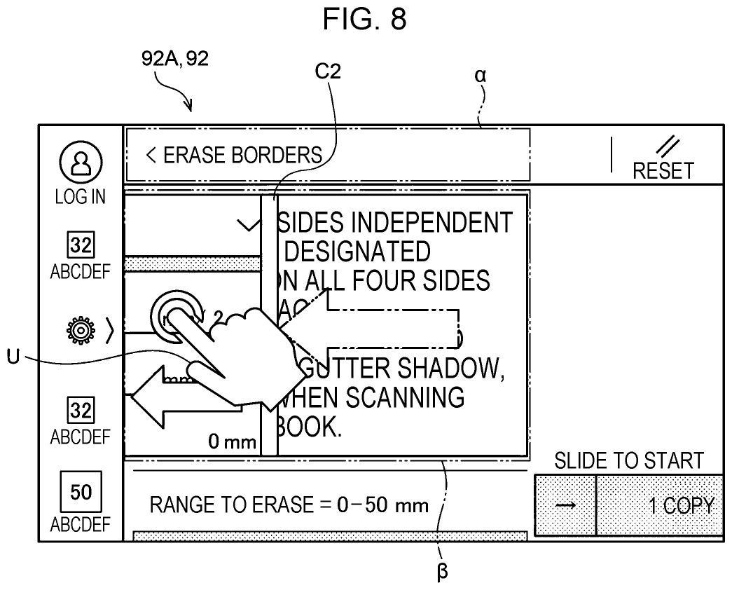

In the first exemplary modification, the user U drags the second area β a predetermined distance or more toward the left-edge side from any spot within the second area β where the second operation item is displayed on the display screen 92A of the display unit 92. When the user U drags the second area β, as illustrated in FIG. 8, the guidance message beings to be displayed instead of the second operation item in the second area β.

### Second Exemplary Modification

As another example, the exemplary embodiment above may adopt the following second exemplary modification. The second exemplary modification shares the same basic configuration as the exemplary embodiment above. In the exemplary embodiment above, the entire guidance message is displayed in the second area β. The second exemplary modification mostly differs in that if only a portion of the guidance message is displayed in the second area, the guidance message may be scrolled in a designated direction (up or down) and a designated distance according to a drag operation.

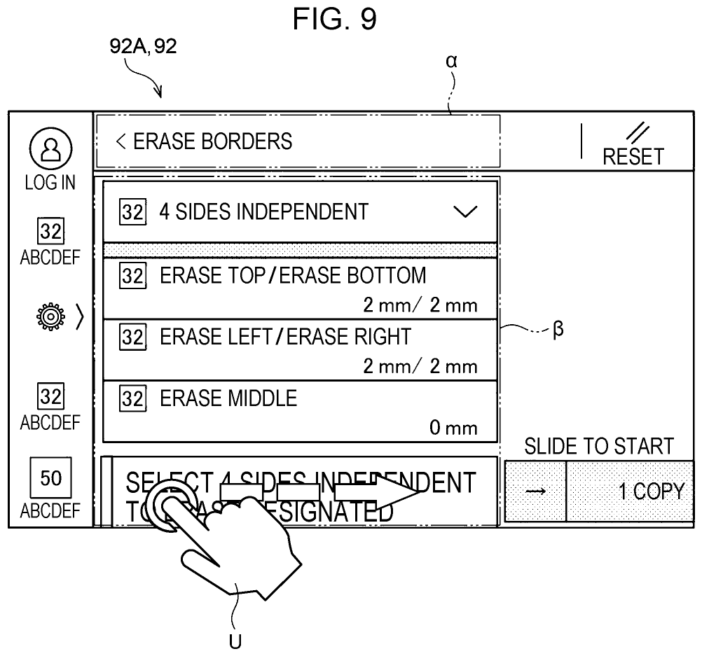

As illustrated in FIG. 9, in the second exemplary modification, the second area β is located from the center of the display screen 92A downward. In the second area β, the interrelated items “4 sides independent”, “erase top/erase bottom”, “erase left/erase right”, and “erase middle” are arranged and displayed in an independently selectable manner as the second operation item. Also, in the second area β, a guidance message is displayable below the second operation item instead of another second operation item.

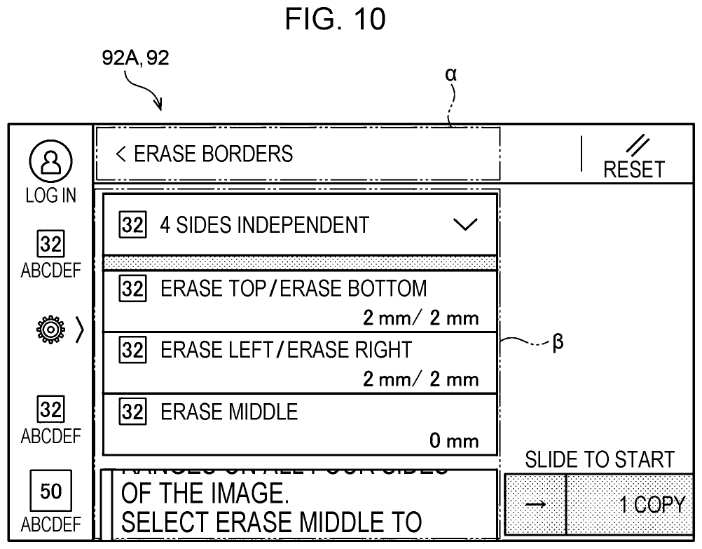

In the second exemplary modification, when the guidance message is displayed in the second area β and only a portion of the guidance message is displayed, dragging the second area β a predetermined distance from the left-edge side to the right-edge side causes the guidance message to be scrolled down in accordance with the distance, resulting in the state illustrated in FIG. 10. In the second exemplary modification, a transition from the state in which the first and second lines are displayed (see FIG. 9) to the state in which the fifth and sixth lines are displayed (see FIG. 10) is illustrated as an example. Dragging is an example of an accepting operation. Also, dragging in a designated direction (up or down) and a designated distance is an example of adjusting the display appearance.

On the other hand, if the second area β is dragged a predetermined distance from the right-edge side to the left-edge side, the guidance message is scrolled up in accordance with the distance.

Note that adjusting the display appearance includes changing the size of characters displayed in the second area β. For example, when the guidance message is displayed in the second area β and only a portion of the guidance message is displayed, pinching in the second area β may cause the character size to become smaller than the current display state. As another example, pinching out the second area β may cause the character size to become larger than the current display state.

With this arrangement, the CPU 72A of the controller 70 according to the second exemplary modification adjusts the display appearance to be displayed in the second area β on the basis of an accepting operation for acquisition of a guidance message.

### Second Exemplary Embodiment

Next, a second exemplary embodiment will be described. In the second exemplary embodiment, the configuration of the second area β of the display screen 92A differs from the first exemplary embodiment. Specifically, in the second area β of the first exemplary embodiment, one guidance message is displayed in the entire second area β instead of the second operation items. In the second area β of the second exemplary embodiment, one guidance message corresponding to one second operation item is displayed individually in the second area β in place of the corresponding second operation item.

Note that the following description of the second exemplary embodiment assumes that the title item “copy” is displayed as the first operation item.

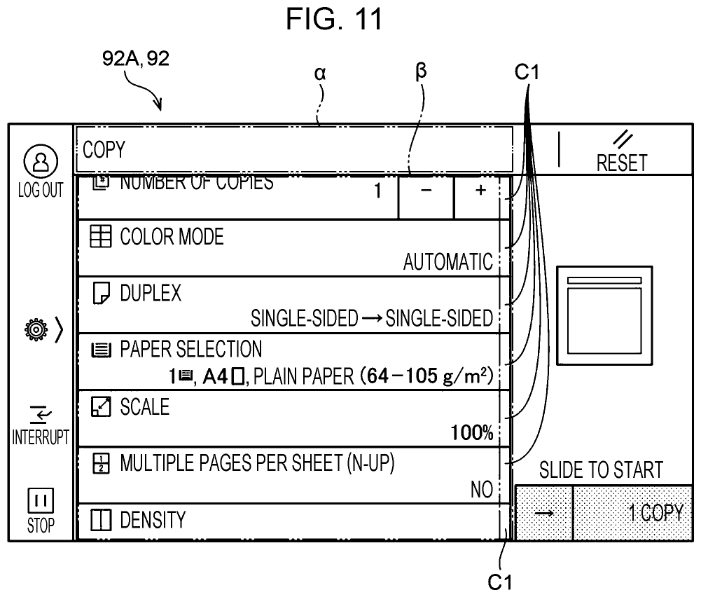

In the present exemplary embodiment, as illustrated in FIG. 11, at least the following seven items are displayed in the second area β of the display screen 92A as second operation items: “number of copies”, “color mode”, “duplex”, “paper selection”, “scale”, “multiple pages per sheet (N-up)”, and “density”. Also, a first call area C1 is assigned to each second operation item. In other words, the first call area C1 of the second exemplary embodiment is subdivided as compared to the first call area C1 of the first exemplary embodiment.

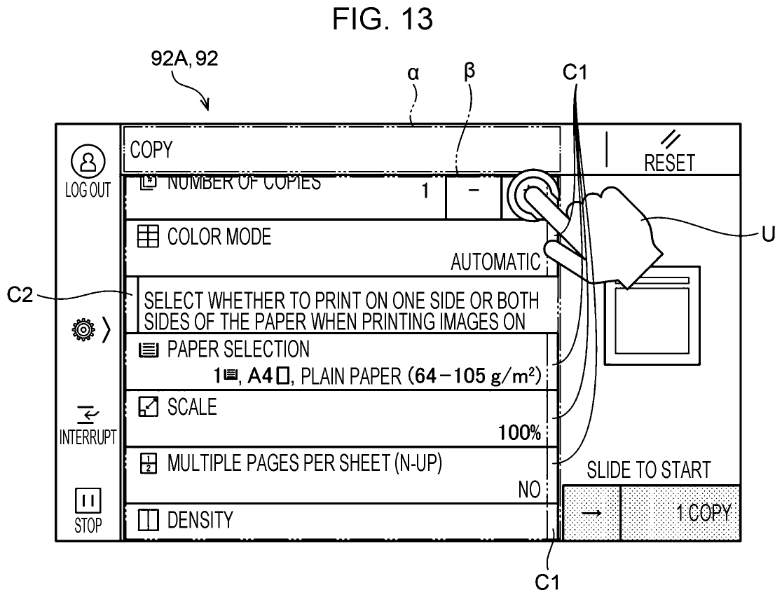

As illustrated in FIG. 13, in the second exemplary embodiment, when a guidance message serving as information related to one second operation item is displayed in the second area in place of the corresponding second operation item, the first operation item continues to be displayed in the first area α, and the other second operation items continue to be displayed in the second area β.

For example, when a guidance message for the second operation item “duplex” is displayed, the first operation item “copy” and at least the other second operation item “number of copies” continue to be displayed, and “number of copies” is changeable.

A second call area C2 is displayed in a left-edge portion of the displayed guidance message.

### (Flowchart)

Next, a Flowchart of the Controller 70 in the Second Exemplary Embodiment Will Be described.

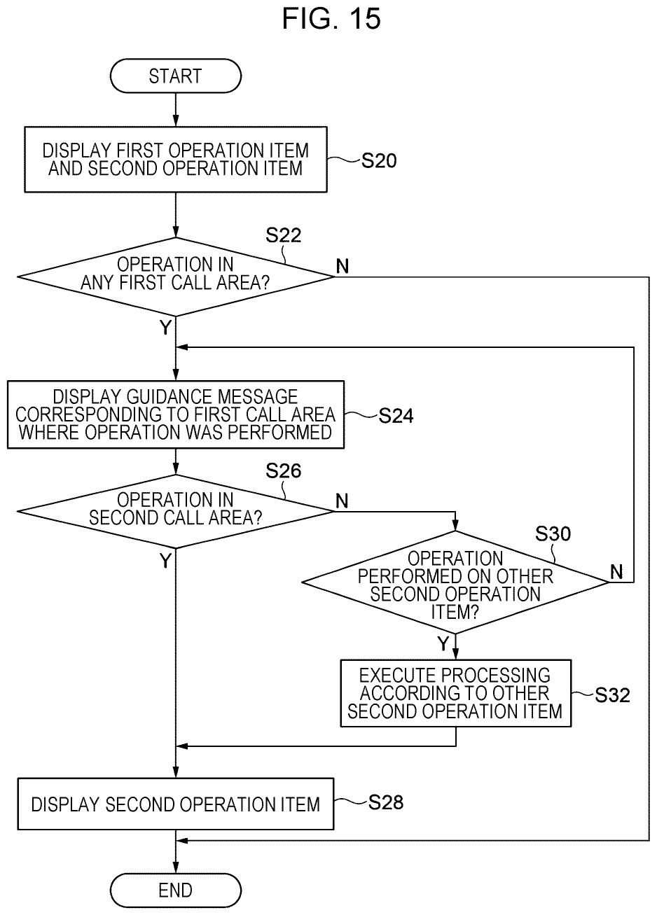

As illustrated in FIG. 15, in step S20, the CPU 72A of the controller 70 causes the first operation item to be displayed in the first area α and causes second operation items to be displayed in the second area β of the display screen 92A. The CPU 72A then proceeds to step S22.

In step S22, the CPU 72A determines whether the first call area C1 of any second operation item is tapped.

If the determination result is “N”, the CPU 72A ends the flow.

On the other hand, if the determination result is “Y”, the CPU 72A proceeds to step S24.

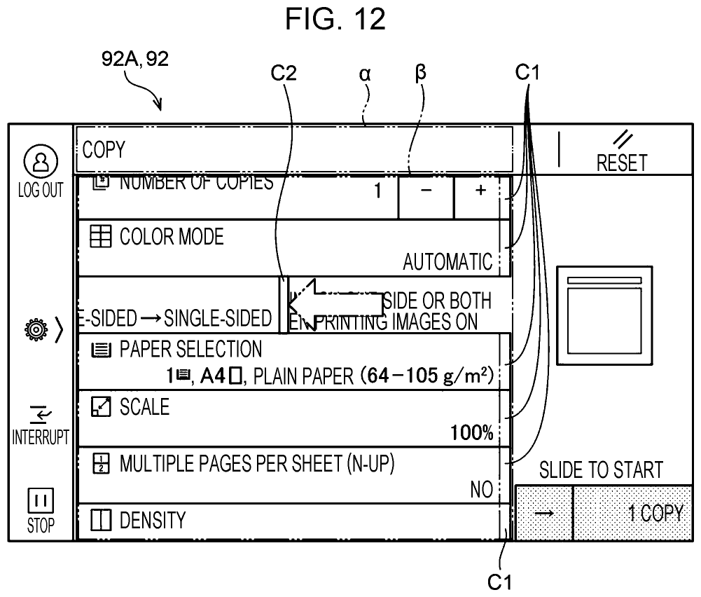

In step S24, the CPU 72A causes a guidance message corresponding to the tapped first call area C1 to be displayed in the second area β of the display screen 92A. For example, as illustrated in FIG. 12, the CPU 72A causes the guidance message for the second operation item “duplex” to be displayed. The CPU 72A then proceeds to step S26.

In step S26, the CPU 72A determines whether the second call area C2 where the guidance message is displayed is tapped.

If the determination result is “Y”, the CPU 72A proceeds to step S28.

On the other hand, if the determination result is “N”, the CPU 72A proceeds to step S30.

In step S30, the CPU 72A determines whether another second operation item is tapped.

If the determination result is “Y”, the CPU 72A proceeds to step S32.

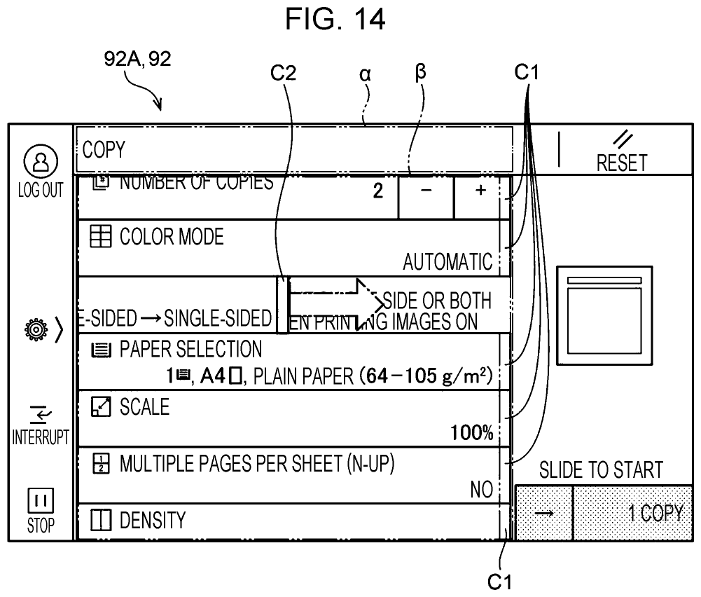

In step S32, the CPU 72A executes processing in accordance with the other second operation item. The CPU 72A then proceeds to step S28. For example, as illustrated in FIG. 13, the CPU 72A executes processing to increase the other second operation item “number of copies” by 1 copy. As a result of executing the processing, as illustrated in FIG. 14, the other second operation item “number of copies” increases to 2 copies.

On the other hand, if the determination result in step S30 is “N”, the CPU 72A proceeds to step S24 until the condition is met.

Upon proceeding to step S28, the CPU 72A causes the second operation item to be displayed in the second area β of the display screen 92A. For example, as illustrated in FIG. 14, the CPU 72A causes the second operation item “duplex” to be displayed in place of the guidance message for the second operation item “duplex”. The CPU 72A then ends the flow.

With this arrangement, the displaying of a guidance message by the controller 70 of the second exemplary embodiment is carried out.

### Exemplary Modifications

The foregoing describes the second exemplary embodiment of the present disclosure with reference to the drawings, but the present disclosure is not limited to such an exemplary embodiment, and it is clear to a person skilled in the art that the present disclosure make take form in various other embodiments within the scope of the present disclosure.

Note that in the following description of exemplary modifications, reference signs and descriptions may be reduced or omitted with respect to configurations and functions shared in common with the exemplary embodiment above.

### Exemplary Modification of Second Exemplary Embodiment

As an example, the second exemplary embodiment above may adopt the following exemplary modification. The exemplary modification shares the same basic configuration as the second exemplary embodiment above. The exemplary modification differs from the second exemplary embodiment in that the display inside the second area β is scrolled up after the first call area C1 is tapped.

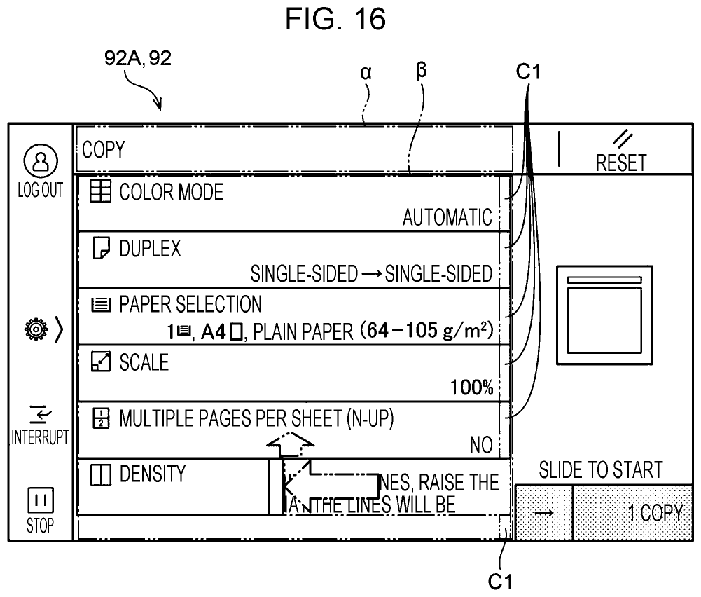

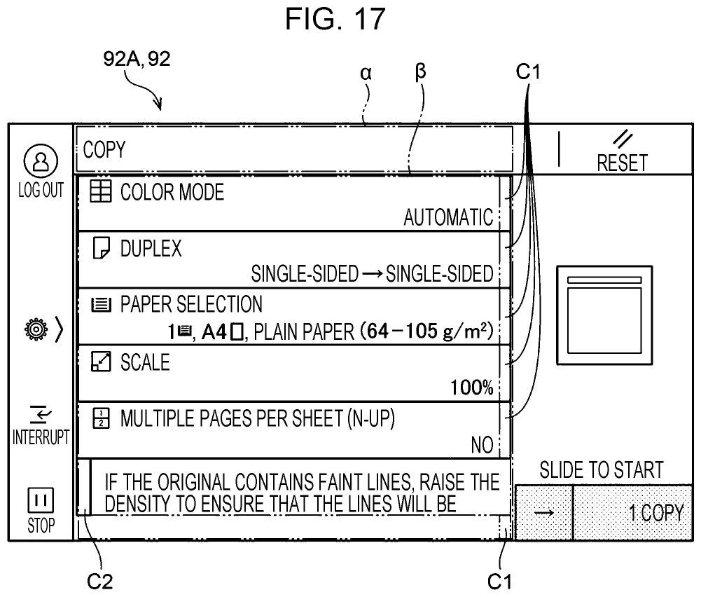

As illustrated in FIG. 11, the second operation item “density” is displayed in a partially cut-off state at the bottom of the second area β of the display screen 92A. If the first call area C1 of the second operation item “density” is tapped, the display transitions through the state illustrated in FIG. 16 to the state illustrated in FIG. 17. In other words, the entire second area β is moved on the display screen 92A so that all of the second operation item “density” is displayed. On the other hand, the second operation item “number of copies” that had been partially displayed at the top of the second area β of the display screen 92A (see FIG. 11) goes out of view due to the entire second area β being moved on the display screen 92A.

In the exemplary modification of the second exemplary embodiment, when acquisition of information pertaining to the second operation item “density” displayed only partially in the second area β is accepted, the entire second area β is moved on the display screen 92A such that the information is displayed in the second area β.

Note that in this exemplary modification, the exemplary modifications of the first exemplary embodiment may also be applied in cases where the guidance message displayed in the second area β is cut off.

### Other Exemplary Modifications

The image forming device 10 is not limited to the example of an electrophotographic image forming device 10 and may also be, for instance, an inkjet image forming device, and any of various types of image forming devices are usable. In an inkjet image forming device, for example, an image is formed onto a recording medium by ejecting ink droplets onto the recording medium from an ejection unit (not illustrated).

In the exemplary embodiments above, the touch panel 90 is used to describe the display screen 92A of the display unit 92, but the display unit 92 need not be a touch panel. For example, the user U may also operate a keyboard and mouse or some other user interface that functions as the accepting unit 94 while referring to a screen on a monitor that functions as the display screen 92A of the display unit 92.

In the exemplary embodiments above, a guidance message is displayed as information pertaining to a second operation item, but the information pertaining to a second operation item is not limited thereto. For example, a shortcut for calling another operation item not displayed on the display screen 92A may also be displayed as the information pertaining to a second operation item.

In the exemplary embodiments above, the accepting operation or the displaying operation is assumed to be a tap or a drag, but is not limited thereto. The accepting operation or the displaying operation may also be a long press, in which an operation item is pressed continuously for a predetermined time.

In the exemplary embodiments above, the first call area C1 is assumed to be visually indistinguishable from the second area β, but is not limited thereto. For example, the first call area C1 may be visually distinguishable from the second area β by pattern, color, or the like.

In the exemplary embodiments above, the second call area C2 is assumed to be visually distinguishable from the second area β, but is not limited thereto. For example, the second call area C2 may be visually indistinguishable from the second area β.

In the exemplary embodiments above, the first call area C1 is located in a right edge portion of the second area β and the second call area C2 is located in a left edge portion of the second area β, but the locations of the call areas are not limited thereto. For example, the first call area C1 and the second call area C2 may also be located in the same edge portion of the second area β.

In the exemplary embodiments above, the processor causes multiple interrelated operation items to be arranged and displayed in an independently selectable manner in the second area, and upon accepting acquisition of information pertaining to one of the interrelated operation items, causes the information pertaining to an operation item to be displayed in the entire second area, but is not limited thereto. For example, upon accepting acquisition of information pertaining to one of the interrelated operation items, the processor may cause the information pertaining to an operation item to be displayed in a portion of the second area.

In the exemplary embodiments above, the processor causes information pertaining to multiple interrelated operation items to be displayed as the information pertaining to an operation item, but is not limited thereto. For example, the processor may cause information pertaining to one operation item to be displayed as the information pertaining to an operation item.

In the exemplary embodiments above, upon accepting acquisition of information pertaining to an operation item displayed only partially in the second area, the processor causes the entire second area to be moved on the display screen such that the information is displayed in the second area, but is not limited thereto. For example, upon accepting acquisition of the information, the processor may maintain the display of the second area.

In the exemplary embodiments above, the processor adjusts the display appearance to be displayed in the second area on the basis of an accepting operation for acquisition of the information pertaining to an operation item, but is not limited thereto. For example, the processor may also adjust the display appearance to be displayed in the second area irrespective of an accepting operation for acquisition of the information pertaining to an operation item.

In the exemplary embodiments above, upon accepting a displaying operation for an operation item that had been displayed in the second area, the processor ends the display of the information pertaining to an operation item, but is not limited thereto. For example, upon accepting the displaying operation, the processor may maintain the display of the information pertaining to an operation item.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content. The program according to an exemplary embodiment of the present application may also be provided as a program product.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1))) An information processing system comprising:
a processor configured to:
cause one operation item to be displayed in a first area of a display screen;
cause another operation item different from the one operation item to be displayed in a second area different from the first area of the display screen; and
upon accepting acquisition of information pertaining to the other operation item, cause information pertaining to the other operation item to be displayed in the second area while maintaining the display state of the one operation item in the first area.

(((2))) The information processing system according to (((1))), wherein the processor is configured to:
cause a plurality of interrelated operation items to be arranged and displayed in an independently selectable manner in the second area; and
upon accepting acquisition of information pertaining to one of the interrelated operation items, cause information pertaining to the operation item to be displayed in the entire second area.

(((3))) The information processing system according to (((2))), wherein the processor is configured to:
cause information pertaining to the plurality of interrelated operation items to be displayed as the information pertaining to an operation item.

(((4))) The information processing system according to any one of (((1))) to (((3))), wherein the processor is configured to:
upon accepting acquisition of information pertaining to an operation item displayed only partially in the second area, the processor causes the entire second area to be moved on the display screen such that the information is displayed in the second area.

(((5))) The information processing system according to (((4))), wherein the processor is configured to:
adjust a display appearance to be displayed in the second area, the adjustment being based on an accepting operation for acquisition of the information pertaining to an operation item.

(((6))) The information processing system according to any one of (((1))) to (((5))), wherein the processor is configured to:
upon accepting a displaying operation for an operation item that had been displayed in the second area, end the display of the information pertaining to an operation item.

(((7))) The information processing system according to any one of (((1))) to (((6))), wherein the processor is configured to:
upon accepting an operation on the one operation item while the information pertaining to the other operation item is displayed in the second area, proceed to a screen in accordance with the operation.

(((8))) A program causing a computer to execute a process for information processing, the process comprising:
causing one operation item to be displayed in a first area of a display screen; causing another operation item different from the one operation item to be displayed in a second area different from the first area of the display screen; and
upon accepting acquisition of information pertaining to the other operation item, causing information pertaining to the other operation item to be displayed in the second area while maintaining the display state of the one operation item in the first area.

What is claimed is:

1. An information processing system comprising:
a processor configured to:
cause one operation item to be displayed in a first area of a display screen;
cause another operation item different from the one operation item to be displayed in a second area different from the first area of the display screen; and
upon accepting acquisition of information pertaining to the other operation item, cause information pertaining to the other operation item to be displayed in the second area while maintaining the display state of the one operation item in the first area.

2. The information processing system according to claim 1, wherein the processor is configured to:
cause a plurality of interrelated operation items to be arranged and displayed in an independently selectable manner in the second area; and
upon accepting acquisition of information pertaining to one of the interrelated operation items, cause information pertaining to the operation item to be displayed in the entire second area.

3. The information processing system according to claim 2, wherein the processor is configured to:
cause information pertaining to the plurality of interrelated operation items to be displayed as the information pertaining to an operation item.

4. The information processing system according to claim 1, wherein the processor is configured to:
upon accepting acquisition of information pertaining to an operation item displayed only partially in the second area, the processor causes the entire second area to be moved on the display screen such that the information is displayed in the second area.

5. The information processing system according to claim 4, wherein the processor is configured to:
adjust a display appearance to be displayed in the second area, the adjustment being based on an accepting operation for acquisition of the information pertaining to an operation item.

6. The information processing system according to claim 1, wherein the processor is configured to:
upon accepting a displaying operation for an operation item that had been displayed in the second area, end the display of the information pertaining to an operation item.

7. The information processing system according to claim 1, wherein the processor is configured to:
upon accepting an operation on the one operation item while the information pertaining to the other operation item is displayed in the second area, proceed to a screen in accordance with the operation.

8. An information processing method comprising:
causing one operation item to be displayed in a first area of a display screen;
cause another operation item different from the one operation item to be displayed in a second area different from the first area of the display screen; and
upon accepting acquisition of information pertaining to the other operation item, causing information pertaining to the other operation item to be displayed in the second area while maintaining the display state of the one operation item in the first area.

9. A non-transitory computer readable medium storing a program causing a computer to execute a process for information, the process comprising:
causing one operation item to be displayed in a first area of a display screen;
cause another operation item different from the one operation item to be displayed in a second area different from the first area of the display screen; and
upon accepting acquisition of information pertaining to the other operation item, causing information pertaining to the other operation item to be displayed in the second area while maintaining the display state of the one operation item in the first area.
